(19) United States
(12) Patent Application Publication
(10) Pub. No.: US 2020/0210996 A1
(43) Pub. Date: Jul. 2, 2020

(54) SYSTEMS, METHODS, AND PLATFORMS FOR PROVIDING TRACKING THROUGH BLOCKCHAIN NETWORKS

(71) Applicant: Capital One Services, LLC, McLean, VA (US)

(72) Inventors: Joshua Edwards, McLean, VA (US); Abdelkader Benkreira, McLean, VA (US); Michael Bakr Mossoba, McLean, VA (US); WIlliam F. Carroll, II, McLean, VA (US)

(21) Appl. No.: 16/233,407

(22) Filed: Dec. 27, 2018

(51) Int. Cl. G06Q 20/36; G06Q 20/40; H04L 9/06

(52) U.S. Cl. CPC G06Q 20/3674; G06Q 20/4016; H04L 9/0637; G06Q 20/40145; G06Q 20/3678; G06Q 20/3672

(57) ABSTRACT

A method of a reporting node including: storing a distributed blockchain ledger including a plurality of data records associated with respective processed transactions; receiving a first data packet corresponding to a first transaction, the first data packet including first customer identification data, a first transaction amount and a first transaction date and time; posting the first transaction to the ledger; receiving a second data packet corresponding to a second transaction, the second data packet including second customer identification data, a second transaction amount, and a second transaction date and time; posting the second transaction to the ledger; and responsive to determining that the first and second customer identification data correspond to a same customer and that the first and second transaction date and times are within a predetermined period of time, reporting the first and second transactions to a supervisor server.

### FIELD OF INVENTION

The present disclosure relates to systems and methods for tracking, and, more particularly, utilizing a blockchain network to track, verify, and/or compile physical currency across a plurality of institutions.

### BACKGROUND

Digital currency exchange may be authenticated using reliable functionaries (e.g., financial institutions such as banks and credit unions). For example, when a consumer makes an online purchase and pays the same using a bank account, the consumer's bank stands behind the currency exchange. However, such assurances are not available with physical currency. For example, money laundering and counterfeiting remain persistent problems due to the number of banking options available with very little cross-bank tracking of cash withdrawals. Moreover, due to security and privacy concerns (both consumer and institutional), it is difficult for institutions to quickly share information on related customers. Accordingly, there is a need for systems and methods capable of providing cross-bank tracking of cash withdrawals to help prevent money laundering. Certain embodiments of the present disclosure are directed to this and other considerations.

### SUMMARY

Disclosed embodiments provide systems and methods for tracking cash withdrawals using a blockchain network.

According to some embodiments, there is provided a method including: storing, on a reporting node, a distributed blockchain ledger, the ledger including a plurality of data records associated with respective processed transactions, each of a plurality of subscribing servers being associated with a respective financial institution; receiving, by the reporting node, a first data packet corresponding to a first transaction at a first financial institution, the first data packet including first customer identification data, a first transaction amount, a first transaction location, and a first transaction date and time; posting, by the reporting node, the first transaction to the ledger; receiving, by the reporting node, a second data packet corresponding to a second transaction at a second financial institution, the second data packet including second customer identification data, a second transaction amount, a second transaction location, and a second transaction date and time; posting, by the reporting node the second transaction to the ledger; and responsive to determining, by the reporting node, that the first and second customer identification data correspond to a same customer and that the first and second transaction date and times are within a predetermined period of time, reporting, by the reporting node, the first and second transactions to a supervisor server.

The first data packet may include: the first customer identification data, the first transaction amount, the first transaction location, and the first transaction date and time encoded with a first public key of a first key pair, and a first public customer identifier and a first transaction identifier encoded with a first private key of the first key pair. The first private key may be accessible by a first subscribing server associated with the first financial institution and the reporting node, and the first public key may be accessible by each of the plurality of subscribing servers and the reporting node.

The second data packet may include: the second customer identification data, the second transaction amount, the second transaction location, and the second transaction date and time encoded with a second public key of a second key pair. The second public customer identifier and a second transaction identifier may be encoded with a second private key of the second key pair. The second private key may be accessible by a second subscribing server associated with the second financial institution and the reporting node, and the second public key may be accessible by each of the plurality of subscribing servers and the reporting node.

The method may further include: accessing the first and second customer identification data by decrypting the first and second data packets with the respective first and second private keys; tracking customer identification data corresponding to a plurality of customers over a period of time; identifying two or more transactions over the period of time associated with a same customer identification data; calculating, based on each transaction amount of the two or more transactions, an aggregate transaction amount associated with the same customer identification data over the period of time; and comparing the aggregate transaction amount to a threshold reportable amount.

The reporting may be further responsive to determining, based on the comparing, that the aggregate transaction amount exceeds the threshold reportable amount.

The first customer identification data may include biometric data, the biometric data including at least one of a fingerprint obtained using a fingerprint scanner, a retinal scan obtained using a retinal scanner, a social security number, a driver's license number, or an account number.

The method may further include creating, by the reporting node, a new distributed blockchain ledger every day, the new distributed blockchain ledger being distributed to the plurality of subscribing servers.

The method may further include: executing a hashing algorithm to create a first hash and a respective first block hash for each block of the ledger; updating the hashing algorithm after a predetermined period of time; and executing the updated hashing algorithm to create a second hash and a respective second block hash for each new block added to the ledger.

The plurality of data records may be associated with respective processed transactions exceeding a threshold dollar amount.

According to some embodiments, there is provided a method including: storing, on a first subscribing server of a plurality of subscribing servers, a copy of a distributed blockchain ledger including a plurality of blocks, each of the plurality of subscribing servers being associated with a respective financial institution; receiving, by the first subscribing server, a first data packet corresponding to a first transaction at a first financial institution, the first data packet including first customer identification data, a first transaction amount, a first transaction location, and a first transaction date and time; responsive to receiving an indication from each of the plurality of subscribing servers validating the first data packet, posting, by the first subscribing server, the first transaction to the ledger; receiving, by the first subscribing server, a second data packet corresponding to a second transaction at a second financial institution, the second data packet including second customer identification data, a second transaction amount, a second transaction location, and a second transaction date and time; responsive to receiving an indication from each of the plurality of subscribing servers validating the second data packet, posting the second transaction to the ledger; and responsive to determining, by the subscribing server, that the first and second customer identification data correspond to a same customer and that the first and second transaction date and times are within a predetermined period of time, sending, by a subscribing server of the plurality of subscribing server, a plurality of data packets including the first and second data packets to a third-party server. The third-party server may be configured to determine whether an aggregate transaction amount of the first and second transactions exceeds a threshold reportable amount and communicate an indication of the first and second transaction to a supervisor server associated with a government agency.

The first customer identification data may include personal data associated with a first customer.

The personal data may include at least one of a fingerprint obtained using a fingerprint scanner, a retinal scan obtained using a retinal scanner, a social security number, a driver's license number, or an account number.

The blockchain ledger may be a private blockchain ledger.

The first and second transaction dates may be the same date.

The plurality of data packets may be associated with respective processed transactions exceeding a threshold transaction amount.

The first data packet may include: the first customer identification data, the first transaction amount, the first transaction location, and the first transaction date and time encoded with a first public key of a first key pair, and a first public customer identifier and a first transaction identifier encoded with a first private key of the first key pair. The first private key may be accessible by a first subscribing server associated with the first financial institution and the third-party server, and the first public key may be accessible by each of the plurality of subscribing servers and the third-party server.

The second data packet may include: the second customer identification data, the second transaction amount, the second transaction location, and the second transaction date and time encoded with a second public key of a second key pair, and a second public customer identifier and a second transaction identifier encoded with a second private key of the second key pair. The second private key may be accessible by a second subscribing server associated with the second financial institution and the third-party server, and the second public key may be accessible by each of the plurality of subscribing servers and the reporting node.

The third-party server may be configured to determine that an aggregate transaction amount of the first and second transactions exceeds a threshold reportable amount by: accessing the first and second customer identification data by decrypting the first and second data packets with the respective first and second private keys; tracking customer identification data corresponding to a plurality of customers over a period of time; identifying two or more transactions over the period of time associated with a same customer identification data; calculating, based on each transaction amount of the two or more transactions, an aggregate transaction amount associated with the same customer identification data over the period of time; and comparing the aggregate transaction amount to a threshold reportable amount.

According to some embodiments, there is provided a system including: at least one memory to store instructions; and one or more processors, coupled with the memory, operable to execute the instructions, that when executed, cause the one or more processors to: store a distributed blockchain ledger, the ledger including a plurality of data records associated with processed transactions exceeding a threshold dollar amount, the ledger including a smart contract; receive a first data packet corresponding to a first transaction at a first financial institution the first data packet including public first customer identification data, a first transaction amount, a first transaction location, and a first transaction date and time; responsive to determining that the first transaction amount exceeds a threshold amount, post the first transaction to the ledger; receive a second data packet corresponding to a second transaction exceeding a threshold amount, the second data packet including public second customer identification data, a second transaction amount, a second transaction location, and a second transaction date and time; responsive to determining that the second transaction amount exceeds the threshold amount, post the second transaction to the blockchain; determine, by the smart contract, that the first and second customer identification data correspond to a same customer and that the first and second transaction date and times are within a predetermined period of time; and communicate, under direction of the smart contract, the first and second transactions to a secure third-party server.

The instructions, when executed, may further cause the one or more processors to: determine, via the smart contract, whether the aggregate transaction amount exceeds a threshold reportable amount; and communicate the first and second transactions to the secure third-party in response to determining that the aggregate transaction amount exceeds the threshold reportable amount.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an example system environment for implementing certain aspects of the present disclosure according to an example embodiment;

FIG. 2 is a diagram of an organizational system according to an example embodiment;

FIG. 3 is a system diagram of a blockchain server according to an example embodiment;

FIG. 4 is a system diagram of a blockchain network according to an example embodiment;

FIGS. 5-7 are flow diagrams of example methods according to an example embodiment.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Various embodiments of the present disclosure provide for tracking cash withdrawals of customers within a period of time and reporting cash withdrawals exceeding a preset dollar amount. For instance, embodiments of the present disclosure may utilize a distributed blockchain ledger to track transactions of various individuals throughout a period of time. Various embodiments of the present disclosure may provide for trusted access to the distributed blockchain ledger using private key pairs. Various embodiments of the present disclosure may provide for identifying customers using biometric data. Various embodiments of the present disclosure may include features for protecting customer private information. The related art approach does not provide any mechanism for tracking or aggregating transactions across multiple, independent organizations. Rather, without disclosing sensitive and private customer information to competitors, such aggregation would not be possible. By tying the reporting mechanism to the technology as discussed herein, embodiments of the present overcome these and other issues.

Reference will now be made in detail to example embodiments of the disclosed technology, examples of which are illustrated in the accompanying drawings and disclosed herein. Wherever convenient, the same references numbers will be used throughout the drawings to refer to the same or like parts.

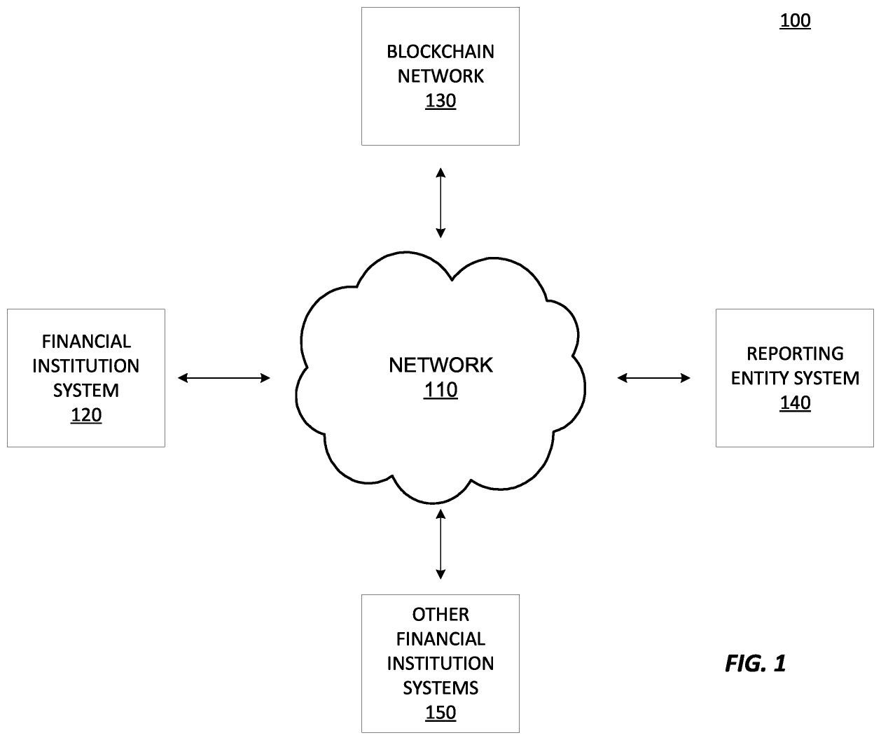

FIG. 1 is a diagram of an example system environment 100 that may be configured to implement one or more aspects of the present disclosure. As illustrated in FIG. 1, system environment 100 can include a network 110, a financial institution system 120, a blockchain network 130, a reporting entity system 140, and other financial institution systems 150. Financial institution system 120 can be in communication with blockchain network 130, reporting entity system 140, and other financial institution systems 150 via network 110.

Network 110 may be of any suitable type, including individual connections via the internet such as wired or wireless networks. The wired networks may be an Ethernet network and the wireless networks may be cellular or WiFi™ networks, for example. In some embodiments, network 110 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In certain embodiments, however, the information being transmitted may be less personal, and therefore the network connections may be selected for convenience over security.

Financial institution system 120 may be associated with a financial institution (e.g., a bank) and be configured to receive cash withdrawal requests from account-holders associated with the financial institution. Account-holders, as referred to herein, may include individuals or businesses having an account with the financial institution. For instance, the account may be a personal checking account, a personal savings account, an operating checking account, a payroll checking account, or a merchant account. In some embodiments, the account-holders may engage in various cash transactions (e.g., cash withdrawals/deposits or check cashing).

In some embodiments, financial institution system 120 may include one or more financial services devices through which account-holders may initiate cash withdrawals. The financial services devices may include automated teller machines (ATMs), desktop computers (e.g., user terminals at brick and mortar branch locations associated with financial institutions, personal computers associated with the user and accessing a web browser), mobile devices associated with an accountholder and configured with a mobile application associated with the accountholder, and point-of-sale (POS) devices associated with a merchant and providing cash-back services.

As discussed in more detail below, financial institution system 120 may be configured to acquire identification data associated with an individual (e.g., account-holder) making a cash withdrawal and store the acquired identification data. In some embodiments, the identification data may include biometric data such as fingerprint scans, palm prints, facial scans, retinal scans, or iris recognition. In some cases, identification data may include a social security number, an account number, a driver's license number, or a passport number. In some embodiments, the identification data may include an assigned identification number (e.g., assigned by the financial institution and/or a controlling node of the blockchain network 130).

Financial institution system 120 may be configured to communicate with blockchain network 130. In certain implementations, financial institution system 120 may transmit transaction data and identification data to blockchain network 130 for processing and monitoring. In some embodiments, transaction data may include a transaction amount, a transaction location (e.g., a branch identification number associated with the withdrawal, an ATM identification number, or a merchant code associated with a merchant), and a transaction date and time.

Blockchain network 130 may store a distributed blockchain ledger on each of a plurality of nodes (e.g., subscribing servers) to blockchain network 130 related to account-holder cash withdrawals at subscribing financial institutions. In some embodiments, each of financial institution system 120 and other financial institution systems 150 may include one or more servers connected to the blockchain network 130. Each of the plurality of subscribing servers can be associated with a respective financial institution. In some embodiments, blockchain network 130 may be a private blockchain in which each of the financial institutions is a subscriber.

Reporting entity system 140 may be configured to analyze the transactions posted to a blockchain (e.g., supported by blockchain network 130). In some cases, reporting entity system 140 may report a plurality of transactions to a government agency if the cumulative value of the plurality of transactions exceeds a legally-imposed limit. For instance, in the case of an individual, reporting entity system 140 may receive an indication from blockchain network 130 that an individual has made a predetermined number of cash withdrawals (e.g., two or more) in a single day, and determine if an aggregate dollar amount of the cash withdrawals exceeds a threshold (e.g., $10,000). If the aggregate withdrawal amount exceeds the threshold, reporting entity system 140 may send a notification to a government agency identifying the individual (e.g., with biometric data) and records of the transactions made by the individual. In some cases, reporting entity system 140 may be a system of a trusted third-party (e.g., an industry association or a joint venture) connected with the blockchain.

Those skilled in the art will understand that other financial institution systems 150 may have some or all the features discussed above with respect to financial institution system 120. Accordingly, a separate detailed description will not be repeated for compactness.

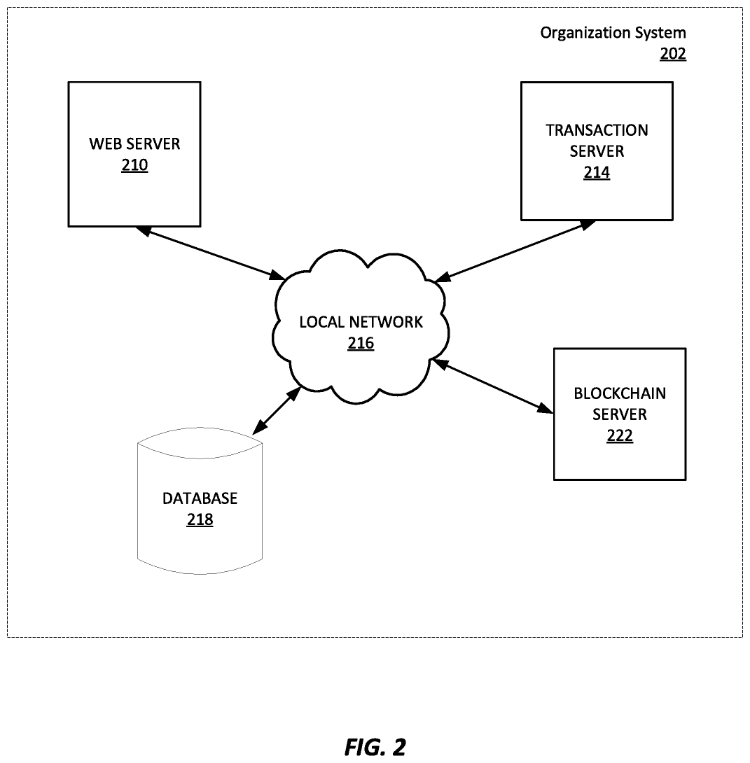

FIG. 2 is an example diagram of an organizational system 202, in accordance with some embodiments of the present disclosure. Organizational system 202 may be associated with an entity (e.g., an organization) such as a business, corporation, individual, partnership, or any other entity that provides one or more of goods, services, and consultations to individuals such as customers. Financial institution system 120 and other financial institution systems 150 can include some or all the features of organizational system 202. Organizational system 202 can include a web server 210, a transaction server 214, local network 216, database 218, and blockchain server 222.

Organizational system 202 may include one or more servers, devices, and computer systems for performing one or more functions associated with products and/or services that the organization provides. Such servers, devices, and computer systems may include, for example, web server 210, transaction server 214, blockchain server 222, and database 218, as well as other computer systems necessary to accomplish tasks associated with the organization.

Web server 210 may include a computer system configured to provide web access or access to a mobile application or webpage associated with organizational system 202. Web server 210 may include one or more physical of logical computing devices that are configured to provide a user interface to a computing device (e.g., a user terminal associated the with the organization, a mobile device associated with an account-holder) accessing a webpage associated with the organization. Information stored on web server 210 may be accessed (e.g., retrieved, updated, and added to) via local network 216 by one or more devices (e.g., web server 210, transaction server 214, database 218, and blockchain server 222) of organizational system 202.

Transaction server 214 may include a computer system configured to acquire and store transaction data associated with a plurality of transactions of account-holders of the organization. Transaction server 214 may include one or more computing devices that are configured to acquire, and store transaction data associated with a plurality of transactions of account-holders. In some embodiments, transaction server 214 may receive transaction data from one or more merchants associated with purchases made at one or more merchants and store the transaction data. In some cases, transaction server 214 may receive transaction data from one or more of financial services including ATMs, desktop computers (e.g., user terminals at brick and mortar branch locations associated with financial institutions, personal computers associated with the user and accessing a web browser), mobile devices associated with an accountholder and configured with a mobile application associated with the accountholder, and point-of-sale (POS) devices associated with a merchant. In some embodiments, the transaction data may include account-holder biometric data (e.g., fingerprint scans, palm prints, facial recognition, retinal scans, or iris recognition), a transaction amount, a transaction location (e.g., a branch identification number associated with the withdrawal, an ATM identification number, or a merchant code associated with a merchant), and a timestamp (e.g., transaction date and time). In some embodiments, transaction server 214 may then store the transaction information in a transaction database (e.g., database 218).

Database 218 may be a database associated with the organization that stores a variety of information relating to customers, transactions, and/or business operations. Database 218 may also serve as a backup storage device and may contain data and information that is also stored on, for example, local databases associated with web server 210, transaction server 214, and blockchain server 222.

Blockchain server 222 may include a computer system configured to connect with a blockchain network (e.g., blockchain network 130). Blockchain server 222 may be a node on the blockchain network 130 and may be configured to store a distributed blockchain ledger related to account-holder cash withdrawals at subscribing financial institutions (e.g., the organization).

Although the preceding description describes various functions of web server 210, transaction server 214, database 218, and blockchain server 222, in some implementations, some or all these functions may be carried out by a single computing device.

The steps or processes disclosed herein are not limited to being performed in the order described, but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

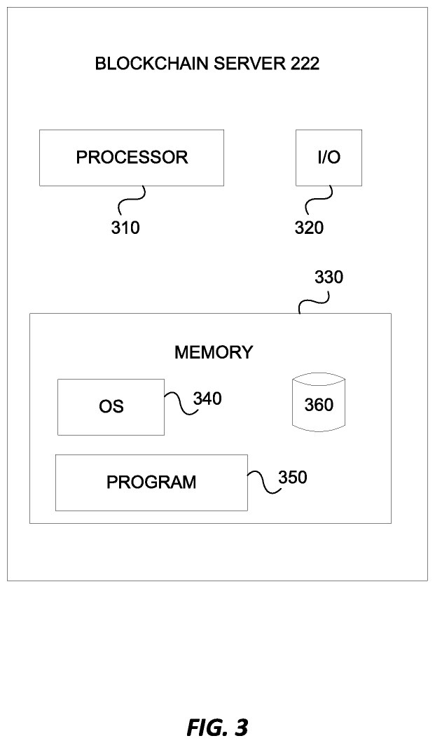

An example embodiment of blockchain server 222 is shown in more detail in FIG. 3. Web server 210 and transaction server 214 may have a similar structure and may include many components that are similar to or even have the same capabilities as those described with respect to blockchain server 222. As shown, blockchain server 222 may include a processor 310, an input/output (“I/O”) device 320, a memory 330 containing an operating system (“OS”) 340 and a program 350. For example, blockchain server 222 may be a single device or server or may be configured as a distributed computer system including multiple servers, devices, or computers that interoperate to perform one or more of the processes and functionalities associated with the disclosed embodiments. In some embodiments, blockchain server 222 may further include a peripheral interface, a transceiver, a mobile network interface in communication with the processor 310, a bus configured to facilitate communication between the various components of blockchain server 222, and a power source configured to power one or more components of blockchain server 222.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, a local area network, or another wide-area network. In some embodiments, a mobile network interface may include hardware, firmware, and/or software that allows the processor(s) 310 to communicate with other devices via wired or wireless networks, whether local or wide area, private or public, as known in the art. A power source may be configured to provide an appropriate alternating current (AC) or direct current (DC) to power components.

Processor 310 may include one or more of a microprocessor, microcontroller, digital signal processor, co-processor or the like or combinations thereof capable of executing stored instructions and operating upon stored data. Memory 330 may include, in some implementations, one or more suitable types of memory (e.g. such as volatile or non-volatile memory, random access memory (RAM), read-only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 330.

Processor 310 may be one or more known processing devices, such as a microprocessor from the Pentium™ family manufactured by Intel™ or the Turion™ family manufactured by AMD™. Processor 310 may constitute a single core or multiple core processor that executes parallel processes simultaneously. For example, processor 310 may be a single core processor that is configured with virtual processing technologies. In certain embodiments, processor 310 may use logical processors to simultaneously execute and control multiple processes. Processor 310 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Blockchain server 222 may include one or more storage devices configured to store information used by processor 310 (or other components) to perform certain functions related to the disclosed embodiments. In some embodiments, blockchain server 222 may include memory 330 that includes instructions to enable processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In some embodiments, blockchain server 222 may include memory 330 that includes instructions that, when executed by processor 310, perform one or more processes consistent with the functionalities disclosed herein. Methods, systems, and articles of manufacture consistent with disclosed embodiments are not limited to separate programs or computers configured to perform dedicated tasks. For example, blockchain server 222 may include memory 330 that may include one or more programs 350 to perform one or more functions of the disclosed embodiments. Moreover, processor 310 may execute one or more programs 350 located remotely from organizational system 202. For example, organizational system 202 may access one or more remote programs 350, that, when executed, perform functions related to disclosed embodiments.

Memory 330 may include one or more memory devices that store data and instructions used to perform one or more features of the disclosed embodiments. Memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. Memory 330 may include software components that, when executed by processor 310, perform one or more processes consistent with the disclosed embodiments. In some embodiments, memory 330 may be a database 360 for storing related data to enable blockchain server 222 to perform one or more of the processes and functionalities associated with the disclosed embodiments.

Blockchain server 222 may also be communicatively connected to one or more memory devices (e.g., databases) locally or through a network. The remote memory devices may be configured to store information and may be accessed and/or managed by blockchain server 222. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

Blockchain server 222 may also include one or more I/O devices 320 that may include one or more interfaces for receiving signals or input from devices and providing signals or output to one or more devices that allow data to be received and/or transmitted by blockchain server 222. For example, blockchain server 222 may include interface components, which may provide interfaces to one or more input devices, such as one or more keyboards, mouse devices, touch screens, track pads, trackballs, scroll wheels, digital cameras, microphones, sensors, and the like, that enable blockchain server 222 to receive data from one or more devices.

In certain embodiments of the disclosed technology, blockchain server 222 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

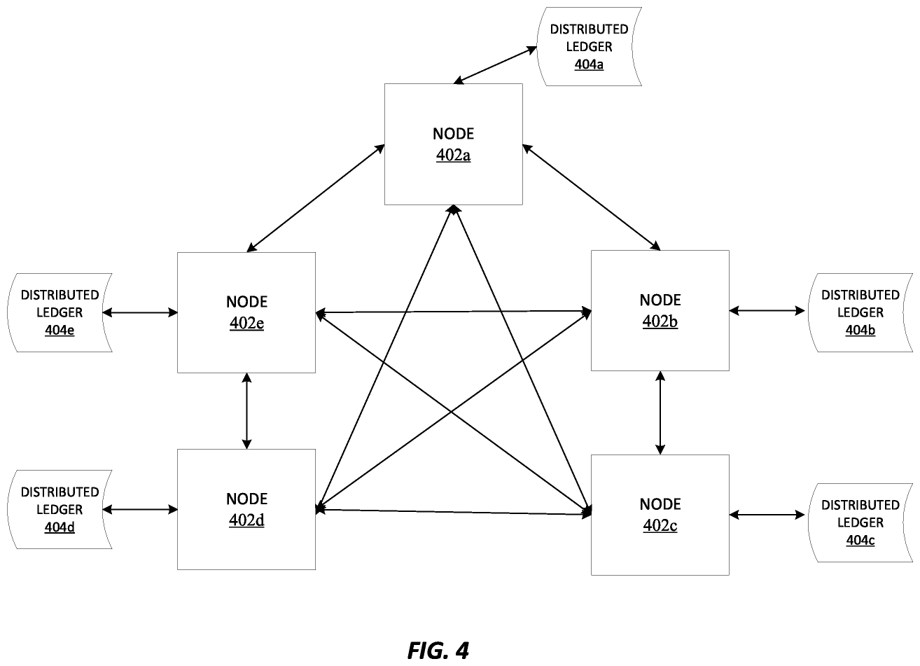

FIG. 4 illustrates an example blockchain network 130, in accordance with some embodiments of the present disclosure. Blockchain network 130 may include a plurality of nodes (402a, 402b, 402c, 402d, 402e) each storing distributed ledger (404a, 404b, 404c, 404d, 404e). Each node 402a-402e may be stored on, for example, a blockchain server 222 of a subscribing organization. In some embodiments, the distributed blockchain ledger may store a plurality of data records associated with processed transactions conducted by account-holders of a plurality of organizations. For instance, the distributed blockchain ledger may include a plurality of data records associated with respective processed transactions. In some implementations, the plurality of data records can include a public data component and a private data component. The public data component can include a public customer identifier and a transaction identifier encoded/encrypted with a private key of a key pair. In some embodiments, a public customer identifier can include a randomly assigned number and the randomly assigned number can be tied to biometric data associated with the user. In some cases, the customer identifier could be a hash of personally identifiable information of the customer (e.g., social security number and date of birth). For instance, all subscribing financial institutions to the blockchain may utilize a same number for a same user (e.g., account holder) or a same or related biometric data. The private data component may be encoded/encrypted with a public key of the key pair. The private data component may include the corresponding biometric data, as discussed previously.

In some embodiments, the distributed ledger can include a series of blocks. Each block may be generated by a hashing algorithm (e.g., based on a previous block and intervening transactions). As non-limiting examples, the hashing algorithm may comport with SHA-2 (Secure Hashing Algorithm 2), SHA-256, and/or SHA-512. For instance, the hash may include hash values. In some embodiments, the hashing algorithm can be updated after a predetermined period of time. For instance, the predetermined period of time can be every day, every week, every month, or a period of years.

In some embodiments, the plurality of blocks of the distributed ledger can store information associated with transactions processed and verified by the blockchain that exceed a threshold dollar amount. For example, the blockchain may include logic configured to analyze transactions submitted by subscribing servers and only enable posting of transactions above a threshold dollar amount. In some cases, each blockchain server 222 may independently verify the dollar amount of every transaction before posting it to a local copy of the ledger. In certain instances, the transaction amount may be encrypted (e.g., with a private key), and the blockchain nodes may decrypt the transaction amount (e.g., with a corresponding public key) to confirm the same.

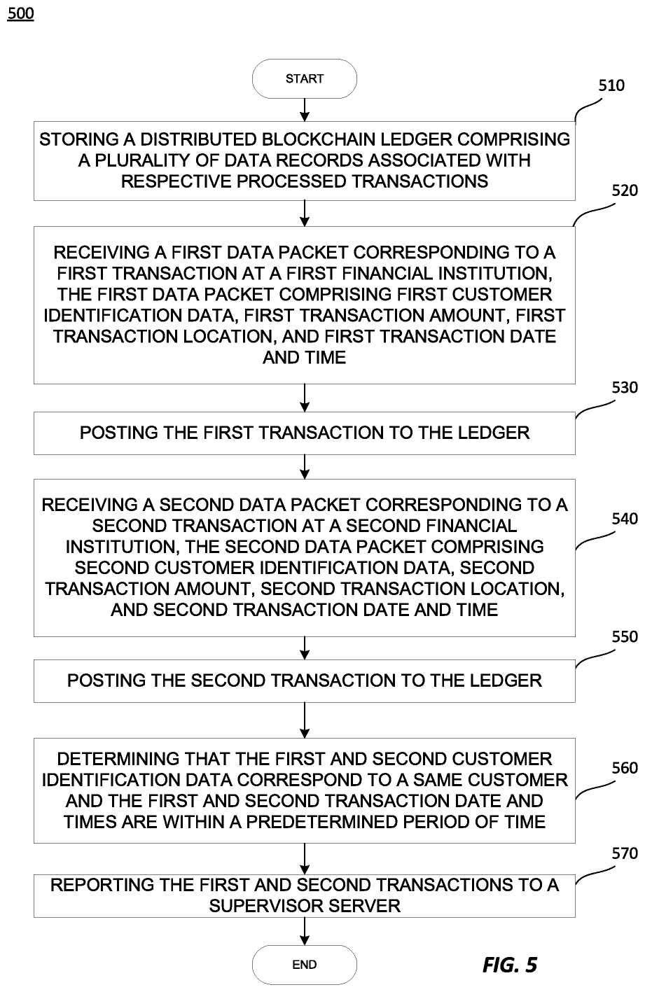

FIG. 5 illustrates a method 500 in accordance with some embodiments of the present disclosure. The method 500 may be implemented, for example, by financial institution system 120 (e.g., blockchain server 222) an/or reporting entity system 140. The method 500 may include storing 510 a distributed blockchain ledger including a plurality of data records associated with respective processed transactions. The data records may be associated with respective processed transactions exceeding a threshold dollar amount. In some embodiments, the distributed blockchain ledger may be stored on a node (e.g., reporting entity system 140 or blockchain server 222) such as a reporting node. In some embodiments, the reporting node may include one of a server associated with an organization or a trusted third-party server (e.g., reporting entity system 140) connected with the blockchain. In some embodiments, the reporting node can be in communication with a government entity and report suspicious transactions or groups of the transaction (e.g., cash withdrawals exceeding a certain amount or cumulative withdrawals over a predetermined period). In some embodiments, the reporting node may create a new distributed blockchain ledger every day or may fork the blockchain every day. In some embodiments, a copy of the distributed blockchain ledger can be stored on a subscribing server associated with a financial institution. In some embodiments, copies of the distributed blockchain ledger may be stored on a plurality of subscribing servers, each subscribing server associated with a respective financial institution.

Method 500 may include receiving 520 a first data packet corresponding to a first transaction at a first financial institution. The first data packet may include first customer identification data, a first transaction amount, a first transaction location, and a first transaction date and time. In some embodiments, the first customer identification data, the first transaction amount, the first transaction location, and the first transaction date and may be time encoded with a first public key of a first key pair. In some cases, the first data packet may include the first public customer identifier and a first transaction identifier. The first public customer identifier and a first transaction identifier may be encoded with a first private key of the first key pair. In some embodiments, the first private key may be accessible by a first subscribing server associated with the first financial institution and the reporting node, and the first public key may be accessible by each of the plurality of subscribing servers and the reporting node. In some embodiments, customer identification data may personal data such as including biometric data such as fingerprint scans, palm prints, facial recognition, retinal scans, or iris recognition. In some embodiments, customer identification data may include may personal data such as a social security number, an account number, a driver's license number, or a passport number. In some embodiments, the customer identification data may include an assigned identification number. In some embodiments, a transaction location can include one or more of a branch identification number associated with the withdrawal, an ATM identification number, or a merchant code associated with a merchant. In some embodiments, the customer identification data may be generated by a hash of one or more items of personal data.

Method 500 may include posting 530 the first transaction to the ledger. In some embodiments, posting the first transaction to the ledger may include executing a hashing algorithm to create a first hash and a respective first block hash for each block of the ledger. In some embodiments, method 500 may further include updating the hashing algorithm after a predetermined period of time, and executing the updated hashing algorithm to create a new block added to the ledger.

Method 500 may include receiving 540 a second data packet corresponding to a second transaction at a second financial institution. The second data packet may include second customer identification data, a second transaction amount, a second transaction location, and a second transaction date and time. The second data packet may have some or all the features (e.g., second customer data encoded with a second public key) of the first data packet. In some cases, the data packets could be signed with a second private key (e.g., corresponding to the second financial institution). In some circumstances, customer data in the second data packet may be encoded using a same hashing/salting algorithms and values as the first data packet.

Method 500 may include posting 550 the second transaction to the ledger. Posting 550 the second transaction to the ledger may be substantially similar to posting 530 the first transaction to the ledger. For example, in some embodiments, posting the first transaction to the ledger may include executing a hashing algorithm to create a second hash and a respective second block hash for each block of the ledger. The hashing algorithm may be a same hashing algorithm as that used to create the first hash and the first block hash, or may be an updated or different hashing algorithm.

Method 500 may include determining 560 that the first and second customer identification data correspond to a same customer and the first and second transaction date and times are within a predetermined period of time. In some embodiments, customer identification data corresponding to a plurality of customers may be tracked over a period of time (e.g., a rolling period such as 24 hours, each day, each week, each month, or a combination of periodic time periods and rolling time periods), and multiple transactions corresponding to a same customer (e.g., same customer identification data or different customer identification data corresponding to a same customer) over the period of time can be identified. An aggregate transaction amount can be calculated from the identified multiple transactions (i.e., the multiple transactions corresponding to a same customer), and this aggregate amount can be compared to a reportable threshold for the given time period. For example, the first and second data packets may be decrypted with the respective first and second private keys to determine the first and second customer identification data. If the first and second transactions occur within a same time period, because the customer identification data correspond to a same customer, the first and second transaction amounts may be combined. The combined amount of the first and second transactions may be compared to a threshold reportable amount to determine whether to report the multiple transactions.

Method 500 may include reporting 570 the first and second transactions to a supervisor server. As non-limiting examples, the supervisor server may be associated with a government agency, a trusted third-party (e.g., an industry association), or some other supervisory entity. In some embodiments, the reporting may be further responsive to determining, based on comparing the aggregate transaction amount to a threshold reportable amount, that the aggregate transaction amount exceeds the threshold reportable amount. As non-limiting examples, the threshold reportable amount may be an amount set by law or regulation as a dollar amount that needs to be reported to a government agency. In some cases, the threshold reportable dollar amount may be based on a specific time period (e.g., $10,000 per day).

One of ordinary skill will recognize that this is merely an example. In some cases, each financial institution may use two sets of key pairs to encode the data. In some cases, one public key may be shared with all nodes (e.g., other financial institutions), and the other key may be shared with a reporting node. In some embodiments, each customer may be assigned a unique identifier, for example, derived based on a hash of personally identifiable information. All subscribing nodes may be able to see transaction information, but may only identify the customer based on the unique customer identifier. In some cases, all nodes may use a same hashing algorithm to derive the unique identifier, and, therefore, all nodes that know the customer information (and only those nodes) would be able to match customers.

As a non-limiting example, consider a case where customer A's unique identifier is derived from customer A's birthdate and social security number, and customer A is a customer of financial institution Alpha and Beta, but not Gamma. If customer A performs a first transaction (e.g., withdraw $8,000) at financial institution Alpha, financial institution Alpha would derive customer A's unique identifier and post the transaction to the blockchain. If later, customer A performs a second transaction (e.g., withdraw $3,000) at financial institution Beta, financial institution Beta would derive the same unique identifier for customer A (using the same information and hashing algorithm as financial institution A), and likewise post the second transaction to the blockchain. Seeing that the first transaction for customer A is already on the blockchain (e.g., by observing the unique identifiers), financial institution Beta could report the first and second transactions (e.g., to reporting node or directly to a supervising server). Moreover, financial institution Alpha could observe that the second transaction for customer A has been posted to the blockchain and report the first and second transactions (e.g., to reporting node or directly to a supervising server). Additionally, in some cases, a reporting node on the blockchain could identify the plurality of transactions linked to customer A and report the transactions (e.g., to a supervising server). For example, as discussed, above, the reporting node could decrypt data packets for various transactions to determine customer identities associated with the transactions. If a same customer is found to correspond to a plurality of transactions, the reporting node may forward information about the transactions (e.g., to a supervising server). In some cases, reporting node could also request (e.g., from one or more of financial institutions Alpha and/or Beta) for customer identification information (e.g., name, birthdate, social security number). Meanwhile, financial institution Gamma may see that multiple transactions have occurred for a same customer but would be unable to identify the customer without the customer information.

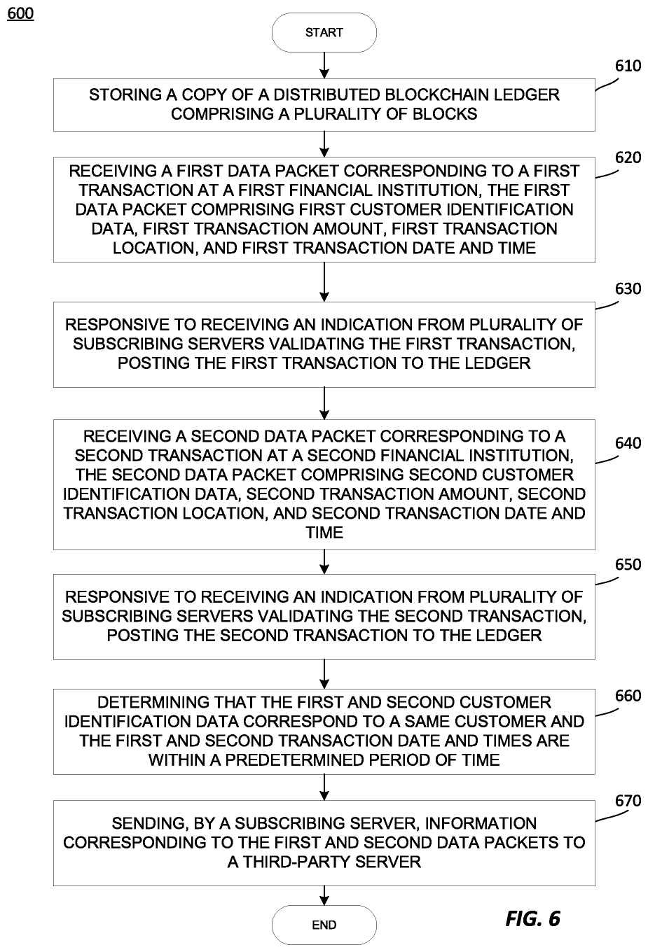

FIG. 6 illustrates a method 600 for tracking cash withdrawals, in accordance with some embodiments of the present disclosure. Elements of method 600 may have some or all the same features as discussed above with respect to similar elements of method 500. Method 600 may include storing 610 a copy of a distributed blockchain ledger including a plurality of blocks. In some embodiments, the distributed blockchain ledger can be stored on at least one subscribing server of a plurality of subscribing servers connected with the blockchain and each of the plurality of subscribing servers can be associated with a respective financial institution. In some embodiments, the blockchain ledger may be a private blockchain ledger.

Method 600 may include receiving 620, by the first subscribing server, a first data packet corresponding to a first transaction at a first financial institution, the first data packet including first customer identification data, a first transaction amount, a first transaction location, and a first transaction date and time. Responsive to receiving an indication from a plurality of subscribing servers validating the first data packet, method 600 may include posting 630, by the first subscribing server, the first transaction to the ledger. For example, the first subscribing server may post 630 the transaction to the ledger when a majority (or plurality) of subscribing servers validate the transaction.

Method 600 may include receiving 640, by the first subscribing server, a second data packet corresponding to a second transaction at a second financial institution, the second data packet including first customer identification data, a second transaction amount, a second transaction location, and a second transaction date and time. In some embodiments, the first and second transaction dates and times may be the same or within a same time period (e.g., day week, 24 hours). Responsive to receiving an indication from a plurality of subscribing servers validating the second data packet, method 600 may include posting 650 the second transaction to the ledger, as will be understood by one of ordinary skill in light of the present disclosure. For example, the first subscribing server may post 650 the second transaction to the ledger when a majority (or plurality) of subscribing servers validate the second transaction.

The subscribing server may determine 660 that the first and second customer identification data corresponds to a same customer and that the first and second transaction date and times are within a predetermined period of time. Responsive thereto, subscribing server may send 670 information corresponding to the first and second data packets to a third-party server. In some embodiments, the third-party server may be configured to determine whether an aggregate transaction amount of the first and second transactions exceeds a threshold reportable amount and report the first and second transaction to a server associated with a government agency.

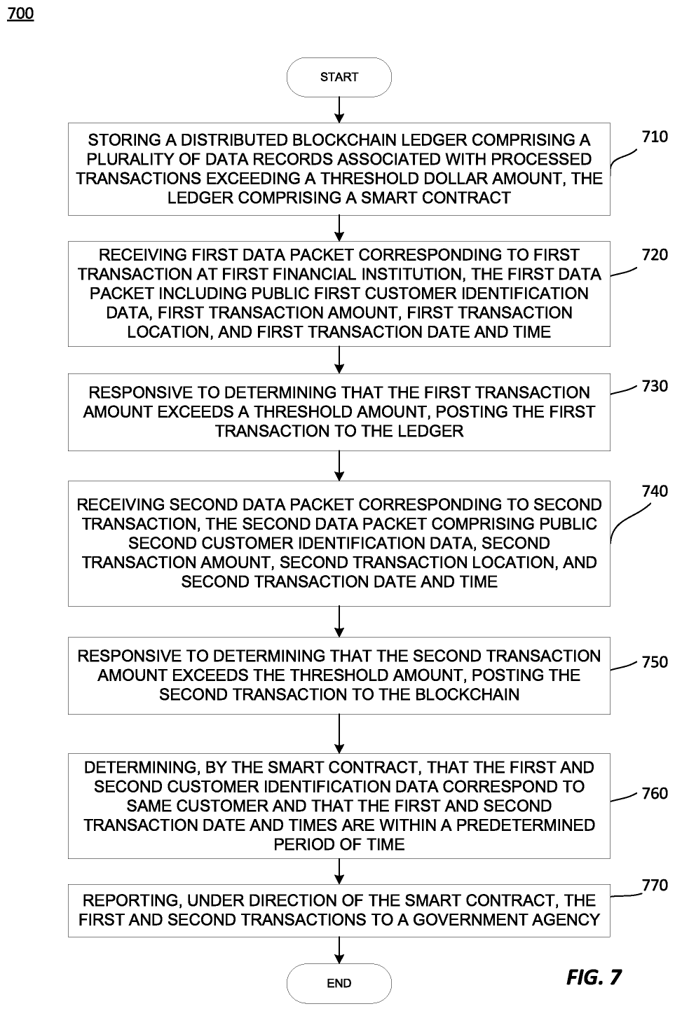

FIG. 7 illustrates a method 700 for tracking cash withdrawals, in accordance with some embodiments of the present disclosure. Elements of method 700 may have some or all the same features as discussed above with respect to similar elements of methods 500 and 600. Method 700 may include storing 710 a distributed blockchain ledger including a plurality of data records associated with processed transactions exceeding a threshold dollar amount, the ledger including a smart contract. Those of skill in the art would understand that a smart contract can include computer code configured to enforce an agreement between subscribers to the blockchain. For example, in some cases, a smart contract may monitor the blockchain looking for a plurality of transactions matching to a single customer (e.g., by identifying a same unique customer identifier included in a plurality of posts). In response to locating a plurality of transactions, the smart contract may trigger, as non-limiting examples, triggering the translation (e.g., de-hashing or matching) of the customer identifier, collecting all of the transactions for the customer, and reporting the plurality of transactions. In some cases, the smart contract may instruct each server (e.g., each financial institution) to separately report (e.g., to a reporting node or a supervising server) the transactions belonging to the unique customer identifier.

Method 700 may include receiving 720 a first data packet corresponding to a first transaction at a first financial institution. In some embodiments, the first data packet may include public first customer identification data, a first transaction amount, a first transaction location, and a first transaction date and time. Responsive to determining that the first transaction amount exceeds a threshold amount, method 700 may include posting 730 the first transaction to the ledger.

Method 700 may include receiving 740 a second data packet corresponding to a second transaction exceeding a threshold amount, the second data packet including public second customer identification data, a second transaction amount, a second transaction location, and a second transaction date and time. Responsive to determining that the second transaction amount exceeds the threshold amount, method 700 may include posting the second transaction to the blockchain.

The smart contract may determine 760 that the first and second customer identification data correspond to a same customer and that the first and second transaction date and times are within a predetermined period of time from each other (e.g., a same day). Method 700 may include reporting 770, under direction of the smart contract, the first and second transactions to a government agency.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution, and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smartphones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “including” or “containing” or “including” is meant that at least the named element, or method step is present in article or method, but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

Although certain embodiments are described with respect to systems and/or methods, one of ordinary skill will recognize that these are merely examples, and certain embodiments with similar features may be alternatively implemented as different categories (e.g., systems, methods, and/or non-transitory computer-readable media).

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Example Use Case

The following example use case describes one example of a typical flow pattern. It is intended solely for explanatory purposes and not in limitation. A financial institution may subscribe to a blockchain network to which several other unaffiliated financial institutions are also subscribers. The blockchain network may be a distributed network and include a ledger. The blockchain network may track transactions by account-holders at one or more of the financial institutions to monitor attempted money-laundering or counterfeit transactions.

An account-holder “AH” may have a checking account with first financial institution “FI1” and second financial institution “FI2.” AH may go to a brick-and-mortar branch associated with FI1 and make a cash withdrawal of $5000 from his account. When attempting the transaction, AH may be asked for a fingerprint ID. Upon completing the transaction, FI1 (e.g., through a server associated with FI1) may send a public record of the transaction including a customer identification number (e.g., hashed and salted version of the fingerprint scan), and non-confidential information about the transaction (e.g., a transaction amount and a transaction date and time). Upon receiving the record of the transaction, each of the subscribing financial institutions to the blockchain may verify the transaction and post the transaction to the ledger.

Later that same day, AH may go to a brick-and-mortar branch associated with FI2 and make a cash withdrawal of $6000 from his account. When attempting the transaction, AH may be asked for a fingerprint ID. Upon completing the transaction, FI2 (e.g., through a server associated with FI2) may send a public record of the transaction including a customer identification number, and non-confidential information about the transaction (e.g., a transaction amount and a transaction date and time). Upon receiving the record of the transaction, each of the subscribing financial institutions to the blockchain may verify the transaction and post the transaction to the ledger.

A reporting node subscribing to the blockchain may, upon identifying two transactions for AH at different financial institutions (FI1 and FI2) report the transactions to a supervisor server (e.g., a trusted third-party server or a governmental entity). In some cases, the reporting node may only report the transactions if they meet some precondition (e.g., a total transaction value exceeding a threshold, such as $10,000),

FI1 and FI2 may encrypt the confidential information (and possible nonconfidential information) in order to protect customer information from being inadvertently disclosed. For example, FI1 may encode the customer information using a first hashing algorithm, and FI2 may encode the customer information using a second hashing algorithm. The reporting node may monitor the transactions and decrypt the customer information (e.g., reverse the first and second hashing respectively) to identify a plurality of transactions to a single customer. In some cases, FI1 and FI2 may encrypt the same customer information using a same hashing algorithm. Accordingly, the transactions may be matched to a single customer by matching unique identifiers. At this point, the reporting node could gather the customer information (e.g., from FI1 and/or FI2) and report the transactions to a supervisor server or instruct FI1 and FI2 to report the transactions separately. In some cases, a later posting institution could identify an early transaction for the same customer and report the transactions (e.g., to the reporting node or to supervisor server).

In another case, the distributed ledger may have a smart contract stored thereon. The blockchain may instruct FI1 to report the first transaction and FI2 to report the second transactions, each including AH's customer information, to a government entity under the direction of the smart contract.

1. A method comprising:
storing, on a reporting node, a distributed blockchain ledger, the ledger comprising a plurality of data records associated with respective processed transactions, each of a plurality of subscribing servers being associated with a respective financial institution;
receiving, by the reporting node, a first data packet corresponding to a first transaction at a first financial institution, the first data packet comprising first customer identification data, a first transaction amount, a first transaction location, and a first transaction date and time;
posting, by the reporting node, the first transaction to the ledger;
receiving, by the reporting node, a second data packet corresponding to a second transaction at a second financial institution, the second data packet comprising second customer identification data, a second transaction amount, a second transaction location, and a second transaction date and time;
posting, by the reporting node the second transaction to the ledger; and
responsive to determining, by the reporting node, that the first and second customer identification data correspond to a same customer and that the first and second transaction date and times are within a predetermined period of time, reporting, by the reporting node, the first and second transactions to a supervisor server.

2. The method of claim 1, wherein
the first data packet comprises:
the first customer identification data, the first transaction amount, the first transaction location, and the first transaction date and time encoded with a first public key of a first key pair, and
a first public customer identifier and a first transaction identifier encoded with a first private key of the first key pair, and
the first private key is accessible by a first subscribing server associated with the first financial institution and the reporting node, and the first public key is accessible by each of the plurality of subscribing servers and the reporting node.

3. The method of claim 2, wherein
the second data packet comprises:
the second customer identification data, the second transaction amount, the second transaction location, and the second transaction date and time encoded with a second public key of a second key pair, and
a second public customer identifier and a second transaction identifier encoded with a second private key of the second key pair, and
the second private key is accessible by a second subscribing server associated with the second financial institution and the reporting node, and the second public key is accessible by each of the plurality of subscribing servers and the reporting node.

4. The method of claim 3 further comprising:
accessing the first and second customer identification data by decrypting the first and second data packets with the respective first and second private keys;
tracking customer identification data corresponding to a plurality of customers over a period of time;
identifying two or more transactions over the period of time associated with a same customer identification data;
calculating, based on each transaction amount of the two or more transactions, an aggregate transaction amount associated with the same customer identification data over the period of time; and
comparing the aggregate transaction amount to a threshold reportable amount.

5. The method of claim 4, wherein the reporting is further responsive to determining, based on the comparing, that the aggregate transaction amount exceeds the threshold reportable amount.

6. The method of claim 1, wherein the first customer identification data comprises biometric data, the biometric data comprising at least one of a fingerprint obtained using a fingerprint scanner, a retinal scan obtained using a retinal scanner, a social security number, a driver's license number, or an account number.

7. The method of claim 1 further comprising creating, by the reporting node, a new distributed blockchain ledger every day, the new distributed blockchain ledger being distributed to the plurality of subscribing servers.

8. The method of claim 1 further comprising:
executing a hashing algorithm to create a first hash and a respective first block hash for each block of the ledger;
updating the hashing algorithm after a predetermined period of time; and
executing the updated hashing algorithm to create a second hash and a respective second block hash for each new block added to the ledger.

9. The method of claim 1, wherein the plurality of data records is associated with respective processed transactions exceeding a threshold dollar amount.

10. A method comprising:
storing, on a first subscribing server of a plurality of subscribing servers, a copy of a distributed blockchain ledger comprising a plurality of blocks, each of the plurality of subscribing servers being associated with a respective financial institution;
receiving, by the first subscribing server, a first data packet corresponding to a first transaction at a first financial institution, the first data packet comprising first customer identification data, a first transaction amount, a first transaction location, and a first transaction date and time;
responsive to receiving an indication from each of the plurality of subscribing servers validating the first data packet, posting, by the first subscribing server, the first transaction to the ledger;
receiving, by the first subscribing server, a second data packet corresponding to a second transaction at a second financial institution, the second data packet comprising second customer identification data, a second transaction amount, a second transaction location, and a second transaction date and time;
responsive to receiving an indication from each of the plurality of subscribing servers validating the second data packet, posting the second transaction to the ledger; and
responsive to determining, by the subscribing server, that the first and second customer identification data correspond to a same customer and that the first and second transaction date and times are within a predetermined period of time, sending, by a subscribing server of the plurality of subscribing server, a plurality of data packets including the first and second data packets to a third-party server,
wherein the third-party server is configured to determine that an aggregate transaction amount of the first and second transactions exceeds a threshold reportable amount by:
accessing the first and second customer identification data by decrypting the first data packet with a first private key and the second data packet with a second private key;
calculating, based on the first and second transactions, the aggregate transaction amount associated with the same customer identification data over the predetermined period of time; and
comparing the aggregate transaction amount to the threshold reportable amount, and
wherein the third-party server is further configured to communicate an indication of the first and second transaction to a supervisor server associated with a government agency when the aggregate transaction amount is determined to exceed the threshold reportable amount.

11. The method of claim 10, wherein the first customer identification data comprises personal data associated with a first customer.

12. The method of claim 11, wherein the personal data comprises at least one of a fingerprint obtained using a fingerprint scanner, a retinal scan obtained using a retinal scanner, a social security number, a driver's license number, or an account number.

13. The method of claim 10, wherein the blockchain ledger is a private blockchain ledger.

14. The method of claim 10, wherein the first and second transaction dates are the same date.

15. The method of claim 10, wherein the plurality of data packets is associated with respective processed transactions exceeding a threshold transaction amount.

16. The method of claim 10, wherein
the first data packet comprises:
the first customer identification data, the first transaction amount, the first transaction location, and the first transaction date and time encoded with a first public key of a first key pair, and
a first public customer identifier and a first transaction identifier encoded with a first private key of the first key pair, and
the first private key is accessible by a first subscribing server associated with the first financial institution and the third-party server, and the first public key is accessible by each of the plurality of subscribing servers and the third-party server.

17. The method of claim 16, wherein
the second data packet comprises:
the second customer identification data, the second transaction amount, the second transaction location, and the second transaction date and time encoded with a second public key of a second key pair, and
a second public customer identifier and a second transaction identifier encoded with a second private key of the second key pair, and
the second private key is accessible by a second subscribing server associated with the second financial institution and the third-party server, and the second public key is accessible by each of the plurality of subscribing servers and the reporting node.

18. (canceled)

19. A system comprising:
at least one memory to store instructions; and
one or more processors, coupled with the memory, operable to execute the instructions, that when executed, cause the one or more processors to:
store a distributed blockchain ledger, the ledger comprising a plurality of data records associated with processed transactions exceeding a threshold dollar amount, the ledger comprising a smart contract;
receive a first data packet corresponding to a first transaction at a first financial institution the first data packet comprising public first customer identification data, a first transaction amount, a first transaction location, and a first transaction date and time;
responsive to determining that the first transaction amount exceeds a threshold amount, post the first transaction to the ledger;
receive a second data packet corresponding to a second transaction exceeding a threshold amount, the second data packet comprising public second customer identification data, a second transaction amount, a second transaction location, and a second transaction date and time;
responsive to determining that the second transaction amount exceeds the threshold amount, post the second transaction to the blockchain;
determine, by the smart contract, that the first and second customer identification data correspond to a same customer and that the first and second transaction date and times are within a predetermined period of time; and
communicate, under direction of the smart contract, the first and second transactions to a secure third-party server.

20. The system of claim 19, wherein the instructions, when executed, further cause the one or more processors to:
determine, via the smart contract, whether the aggregate transaction amount exceeds a threshold reportable amount; and
communicate the first and second transactions to the secure third-party in response to determining that the aggregate transaction amount exceeds the threshold reportable amount.
